(19) United States
(12) Patent Application Publication
(10) Pub. No.: US 2023/0315262 A1
(43) Pub. Date: Oct. 5, 2023

(54) SHARING MULTIPLE APPLICATIONS IN UNIFIED COMMUNICATION

(71) Applicant: Microsoft Technology Licensing, LLC, Redmond, WA (US)

(72) Inventor: Neeraj Surana, Bangalore (IN)

(21) Appl. No.: 17/708,868

(22) Filed: Mar. 30, 2022

(51) Int. Cl. G06F 3/0484; G06F 3/0482; G06F 9/451

(52) U.S. Cl. CPC G06F 3/0484; G06F 3/0482; G06F 9/451; G06F 2203/04803

(57) ABSTRACT

A method and system for managing presentation of multiple applications from a first participant to one or more second participants of a unified communication session are described herein, including receiving, from the first participant, a selected set of applications for display to the one or more second participants during the unified communication session and causing only one of the selected set of applications to be displayed at a time to the one or more second participants through the meeting application, including switching between causing first and second applications of the selected set of applications to be displayed to the one or more second participants based on a most recent selection or user interaction with the first and second applications.

### TECHNICAL FIELD

The present disclosure generally refers to unified communication sessions and more particularly to sharing multiple applications in a unified communication session.

### BACKGROUND

Unified communication sessions provide meeting services, through a meeting application, including audio, video, screen, application, and file sharing capabilities, to bring together and share information between various combinations of in-room, remote, or virtual participants for a shared meeting experience.

### SUMMARY

Embodiments of the present disclosure include a method and system for managing presentation of multiple applications from a first participant to one or more second participants of a unified communication session, comprising receiving, from the first participant, a selected set of applications for display to the one or more second participants during the unified communication session and causing only one of the selected set of applications to be displayed at a time to the one or more second participants through the meeting application, including switching between causing first and second applications of the selected set of applications to be displayed to the one or more second participants based on a most recent selection or user interaction with the first and second applications.

The claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, hard disk, floppy disk, magnetic strips, optical disk, compact disk (CD), digital versatile disk (DVD), smart cards, flash memory devices, among others. In contrast, computer-readable media (i.e., not storage media) may additionally include communication media such as transmission media for wireless signals, etc.

This Summary is provided to introduce a selection of concepts that are further described below in the Detailed Description. It is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The disclosed aspects will hereinafter be described in connection with the appended drawings that are provided to illustrate and not to limit the disclosed aspects.

FIG. 1 illustrates an example system including a meeting service for managing presentation of multiple applications or application windows from a first participant to one or more second participants of a unified communication session.

FIG. 2 illustrates an example unified communication session between a first participant and one or more second participants.

FIGS. 3A through 9B illustrate example respective first and second participant meeting application views of a unified communication session on respective first and second user devices.

FIG. 10 illustrates an example method of managing presentation of multiple applications or application windows from a first participant to one or more second participants of a unified communication session.

FIG. 11 illustrates an example system comprising a user device coupled to a network.

FIG. 12 illustrates an example networking environment including multiple user devices and a meeting service system communicating over a network.

### DETAILED DESCRIPTION

Prior art meeting applications provide sharing of multiple applications, such as by holding a control key and selecting multiple applications during an application selection operation. In response to selection of one or more applications, the prior art meeting application enables sharing of all application windows of the selected applications, and actively shares any active window of the selected applications not fully covered by another application window of the selected one or more applications. Unselected applications in the prior art meeting application do not interfere with sharing of the active windows of the selected one or more applications. For example, a first participant (e.g., a presenter), when sharing first and second applications, can open or navigate to a third application over the top of one or both of the first and second shared applications, without interrupting sharing of the first and second applications with one or more second participants (e.g., an audience). The one or more second participants will see all shared application windows not fully covered by another application window of the shared first and second applications.

However, a technical problem exists with the prior art meeting applications in that all active windows of the selected one or more applications may become visible to the one or more second participants. Thus, in addition to a substantial privacy risk, more screens or applications are often shared than are desired or necessary, increasing the amount of data transmitted, and in certain examples, limiting the quality of such sharing, reducing the effectiveness of the unified communication session, and wasting network resources. In addition, a technical problem exists in the prior art meeting application in that, if all active windows are minimized, the most recent application window in an application window switcher (e.g., an application picker), or in the highest position in a z-order sequence, of the user device of the presenter, remains visible to the participants as a static view until the sharing is stopped, leading to the situation where, if a sensitive document is accidentally shared and then minimized, it can remain displayed to the one or more second participants, even after closing or minimizing, until the sharing operation is stopped or another application window of the selected applications is brought to the topmost or foreground view of the user device of the first participant.

The present inventors have recognized, among other things, technical solutions to the problems described herein, including systems and methods to allow selection of multiple applications or application windows of one or more applications for sharing by a first participant (e.g., a presenter), but causing only one of the selected application windows to be displayed to one or more second participants (e.g., an audience) at a time, and toggling or switching between selected applications through one or more commands or selections to improve user control of presentation during unified communication sessions, to restrict sharing to specific applications or application windows of selected applications, improving user privacy and security, to reduce the amount of data for transmission during unified communication sessions, to improve the quality and resolution of shared information.

In an example, a first participant (e.g., the presenter) can select multiple applications or application windows to be shared to one or more second participants (e.g., the audience), in certain examples, specific application windows of one or more of the selected applications. The first participant can toggle or switch between the individually shared application windows (one at a time) of the one or more selected applications at a time based on, among other things, the most recent active application window (e.g., non-minimized application window) having presenter interaction. In certain examples, presenter interaction can include active navigation to or interaction with the application window, such as causing an active cursor in the application window, or active selection of the application window (e.g., using a pointer, etc.), such as selecting a feature or portion of the application window, etc. In an example, navigation to or selection of an unselected application window by the presenter or an unselected application does not impact sharing to the one or more second participants. Moreover, in certain examples, individual permissions for the one or more second participants can be controlled based on user profile information, or directed by the first participant when setting up the share, such that certain applications or application windows can be shared with specific participants and not others (e.g., participants belonging to a specific group or organization, or within or outside an organization, registered users versus guests, etc.).

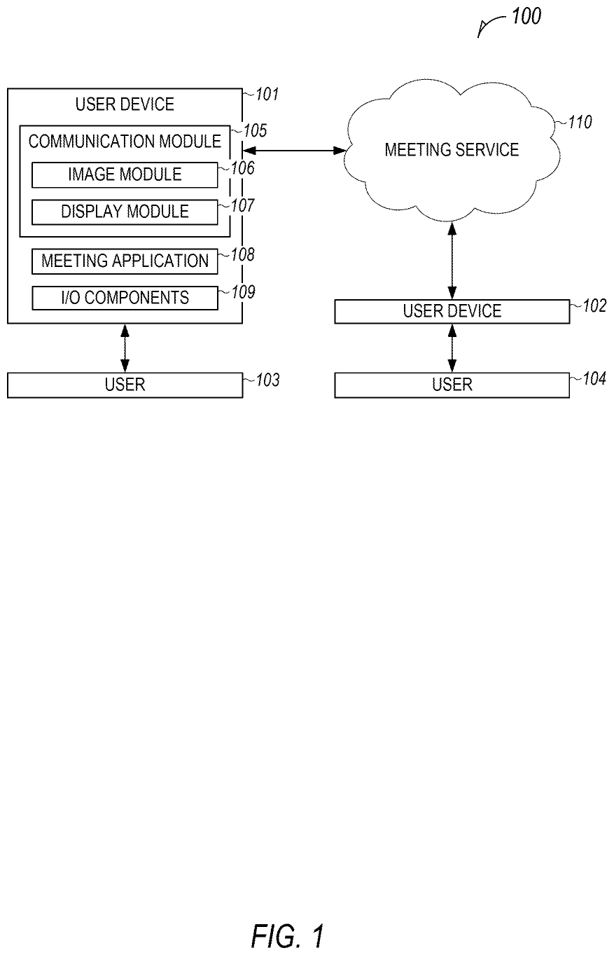

FIG. 1 illustrates an example system 100 including a meeting service 110 for managing presentation of multiple applications or application windows from a first participant (e.g., a presenter) to one or more second participants (e.g., an audience) of a unified communication session through meeting applications of respective first and second user devices 101, 102 (e.g., a mobile phone, laptop computer, desktop computer, tablet, or one or more other electronic devices). The first participant can include a first user 103, such as a presenter, connected to the meeting service 110 through a meeting application 108 executed on the first user device 101, configured to share multiple applications or application windows from the first user device 101 to one or more second participants, such as the second user 104 through respective meeting applications executed on the second user device 102 and connected to the meeting service 110 during the unified communication session.

In an example, the meeting application 108 can include a local client, such as a Microsoft Teams client, a Skype client, etc., installed on a respective user device and connected to the meeting service 110, such as a cloud-based meeting service or platform (e.g., Microsoft Teams, Skype, etc.). In other examples, the meeting application 108 can include a virtual application (e.g., a network-, web-, server-, or cloud-based application) accessing resources of a respective user device, or combinations of a local client and a virtual application, etc. The meeting service 110 can manage unified communication sessions, including communication streams, such as emails, documents, chats, comments, texts, images, animations, hyperlinks, or voice or video communication for users associated with one or more online or other unified communication sessions through meeting applications executed on connected devices, such as the first and second user devices 101, 102 or one or more other devices including hardware and software configured to enable meeting applications or one or more other communication platforms to communicate to or from the respective devices.

The first user device 101 is exemplary of user devices generally, including the second user device 102, etc., and can include a communication module 105 configured to communicate with one or more additional devices, such as the second user device 102, either directly or through the meeting service 110, such as through the meeting application 108. The communication module 105 can be configured to send or receive information to or from the meeting service 110. The communication module 105 can include an image module 106, a display module 107 or one or more other modules configured to adapt data for communication to a user or for transmission to one or more other devices. The image module 106 can be configured to send, receive, or store images associated with the meeting service 110. In certain examples, the images can include icons, such as emojis, representations of emotions (e.g., emoticons), pictures, drawings, avatars, profile pictures, representations of one or more users, etc. In certain examples, the image module 106 can include a repository of images of the first user device 101 or otherwise associated with the first user 103 (e.g., cloud-based storage, online profiles, etc.). The display module 107 can be configured to display messages and other visual content associated with the communication module 105, such as using one or more input/output (I/O) components 109 or portions thereof, such as a display or portion of a display of the first user device 101. The I/O components 109 can include one or more of a display, keyboard, mouse, touch-screen input, camera, microphone, speaker, etc.

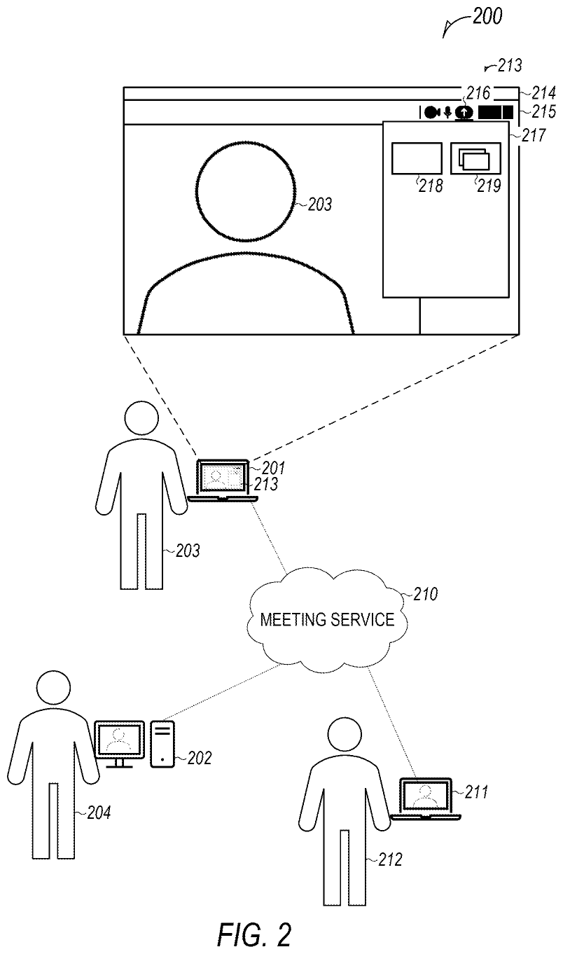

FIG. 2 illustrates an example unified communication session 200 between multiple participants (e.g., a first user 203, a second user 204, a third user 212, etc.) having respective user devices (e.g., a first user device 201, a second user device 202, a third user device 211, etc.) executing respective meeting applications coupled to a meeting service 210, such as through a network connection, over the internet, etc., the meeting service 210 configured to manage the unified communication session 200.

A first participant (e.g., a presenter) of the unified communication session 200, such as the first user 203, can be configured to share information with one or more second participants (e.g., an audience) of the unified communication session 200, such as the second user 204, the third user 212, etc. Shared information can include, in different examples, a representation of the first user 203 (e.g., such as captured through a camera of or coupled to the first user device 201), a video stream of an active screen or a portion of an active screen of the first user device 201 (e.g., screen sharing), one or more applications executed on the first user device 201 (e.g., application or window sharing), or combinations thereof. In an example, the unified communication session 200 can include representations of one or more other participants, in addition to or instead of the representation of the first user 203, in various combinations or configurations. In an example, the one or more applications can include all open application windows of a selected application executed or active on the first user device 201. In another example, the one or more applications can include respective selected application windows of one or more respective application, such as specific selected application windows of the same or different applications executed or active on the first user device 201 (e.g., one or more, some but not all, etc.). Active application can include an application currently open on the first user device 201, currently being executed on the first user device 201, or not closed on the first user device 201. In an example, active applications can include minimized applications or applications operating in the background on the first user device 201. In contrast, active application windows may exclude minimized application windows, and in certain examples, minimized application windows can be restricted from display to the one or more second participants.

The first user device 201 includes a view of a meeting application 213 (e.g., an application window) of the first participant, including, in this example, an optional view of the first user 203. The meeting application 213 includes a title bar 214 optionally including one or more control buttons (e.g., minimize, maximize, close, etc.) and a main area 215 including a control bar having one or more selectable controls. The one or more selectable controls can include, in certain examples, control buttons for one or more actions of the unified communication session 200, such as a camera button to control access to a camera of or coupled to the first user device 201, a microphone button to control access to a microphone (e.g., mute, unmute) of or coupled to the first user device 201, a share button 216 configured to trigger selection of one or more share options for the first participant, a leave button configured to leave or end the unified communication session 200, a participants button to provide a roster of participants of the unified communication session 200, a conversation button to control presentation of a message thread of the unified communication session 200, one or more other control buttons, or combinations thereof.

In an example, selection of the share button 216 can provide access to a share menu 217 providing one or more share options to the first user 203, including a share screen button 218 and a share application button 219. The share screen button 218 can provide a video stream of an active screen or a portion of an active screen of the first user device 201, wherein anything at the topmost or foreground view of a shared portion of a graphical user interface of the first user device 201 will be presented to the one or more second participants (e.g., the audience) of the unified communication session, as it is presented or viewable to the first participant (e.g., the presenter), including intervening interactions, popups, notifications, or movement of undesired applications or interaction over desired presentation material on shared portion of the graphical user interface. In contrast, the share application button 219 can provide a representation of one or more selected applications to the one or more second participants, in certain examples, without exposure of or interruption by one or more other applications, popups, notifications, or activities by the first presenter of unselected applications. In an example, the one or more selected applications can include one or more respective selected application windows of one or more respective applications. Selecting specific applications or application windows (e.g., specific separate windows of a single application, such as a first specific word processing document and not a second word processing document open using the same application) for sharing provides control and protection of shared content, providing enhanced data privacy in contrast to the share screen feature. For example, when sharing an entire screen using the share screen button 218, sensitive information may be inadvertently exposed to the one or more second participants, such as incoming email messages, sensitive information, etc. Selection of specific applications or application windows through the share application button 219 can provides additional user control over shared information with one or more second participants during a unified communication session 200. Selection of the share application button 219 can provide access to a selection menu.

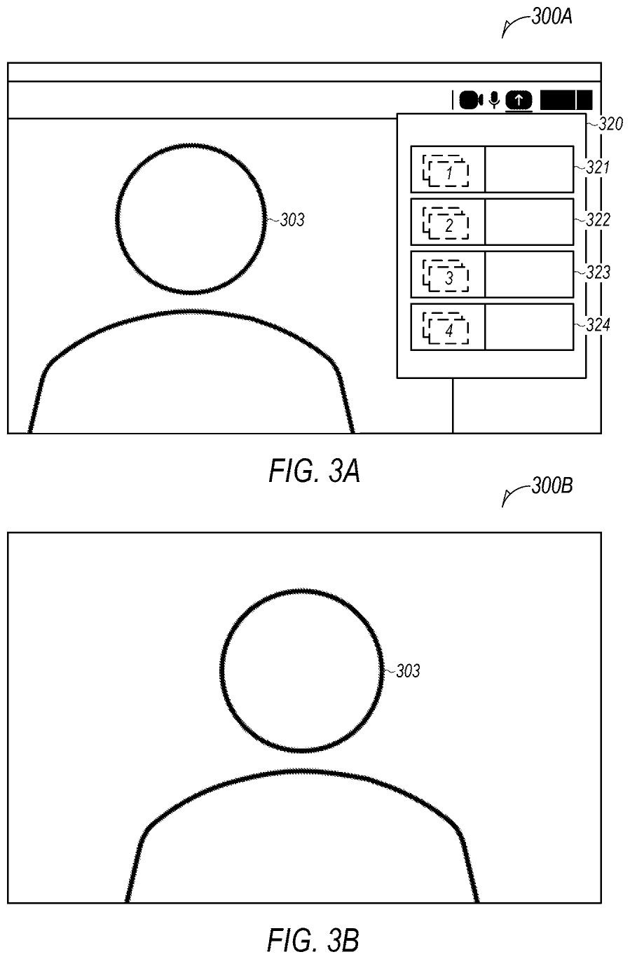

FIGS. 3A and 3B illustrate example respective first and second participant meeting application views 300A, 300B of a unified communication session, including a first participant meeting application view 300A, such as that of a presenter on a first user device, and a second participant meeting application view 300B, such as that of an audience on a second user device. The second participant meeting application view 300B can optionally include a shared representation of a first user 303 (e.g., the first participant, the presenter, etc.) prior to sharing of one or more applications or application windows. In other examples, one or more of the first and second participant meeting application views 300A, 300B can include shared representations of one or more other participants in various combinations or configurations.

Selection of the share application button 219 in FIG. 2 can provide access to a selection menu 320 where a set of selectable applications or application windows can be presented for selection by the first participant for display to one or more second participants. The selection menu 320 can include a set of selectable applications, for example, first, second, third, and fourth applications 321, 322, 323, 324. In an example, the selectable set of applications can include individual, multiple, or all open application windows of a respective active application, or in certain examples, an application executed on the first user device but minimized, currently operating in the background, or otherwise not active on a desktop of the first user device. In other examples, the selectable set of applications can include all open or active application windows of a respective application.

In an example, selecting one of the first, second, third, or fourth applications 321, 322, 323, 324 can provide further selection of respective application windows of the selected application (e.g., selecting an application such as Microsoft Word can trigger further selection of one or more specific active or open Microsoft Word documents, etc.). In other examples, the first, second, third, or fourth applications 321, 322, 323, 324 can themselves be respective application windows of the same or different application (e.g., separate active or open Microsoft Word documents, etc.). In an example, the meeting application can provide for selection of multiple applications for sharing, such as through selection of a multiple select box, holding the control key, etc. In other example, applications or application windows can be selected and unselected (e.g., highlighted for sharing) until a desired combination is achieved, and shared upon confirmation or additional selection of a share button.

Once two or more applications or application windows have been selected for display, the meeting application can cause one of the selected applications or applications windows to be displayed to the one or more second participants. In an example, causing one of the selected applications or application windows to be displayed can include causing only one of the first or second applications to be displayed at a time to the one or more second participants through the meeting application. The first participant can control switching between the two or more applications or application windows, such as by selecting or interacting with the selected application or application window desired to be shared, with a pointer, active cursor, or other user interaction, input, control, or command, etc.

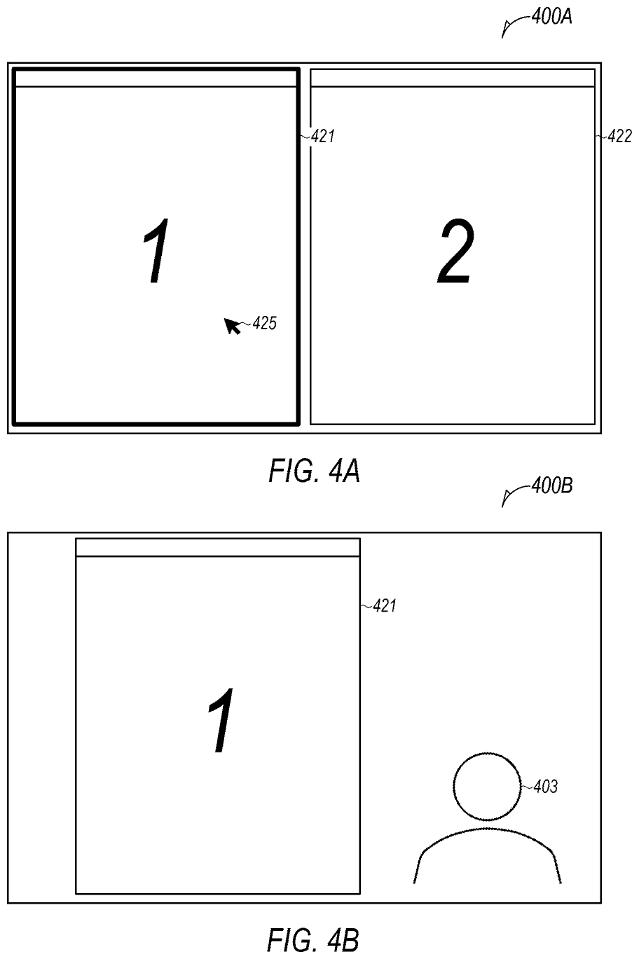

FIGS. 4A and 4B illustrate example first and second participant meeting application views 400A, 400B of a unified communication session, including a first participant meeting application view 400A, such as that of a presenter on a first user device, and a second participant meeting application view 400B, such as that of an audience on a second user device.

In this example, the first participant meeting application view 400A includes a topmost or foreground view of the graphical user interface of the first user device of the first participant, including two applications selected for display to one or more second participants, first and second applications (or application windows) 421, 422 respectively, and a pointer 425. Although illustrated herein as applications, in certain examples the first and second applications 421, 422 can include application windows of the same or different application executed and active (e.g., non-minimized) on the first user device. In contrast, inactive applications or application windows can include applications or applications windows that are not currently being executed on the first user device, operating in the background (e.g., without an active application window on the desktop or graphical user interface of the first user device), minimized to a taskbar or toolbar of the first user device, or in certain examples, not visible to the first participant on the topmost or foreground view of the graphical user interface of the first user device.

The first application 421 is highlighted on the first participant meeting application view 400A as the currently displayed application on the second participant meeting application view 400B. The first and second applications 421, 422 are non-overlapping on the first participant meeting application view 400A, which can include a topmost or foreground view of a graphical user interface of a first user device, or a portion thereof. In certain examples, for the switching described herein, the first and second must not fully overlap on the topmost or foreground view of the graphic user interface of the first user device.

The present inventor has recognized, among other things, that restricting sharing of multiple applications or application windows to sharing one application window at a time can be advantageous in more quickly optimizing sharing with participants having varied screen dimensions, reducing the amount of data communicated during sharing of multiple applications or applications windows, the resolution or quality of information shared in limited bandwidth or connectivity situations, as well as reducing unnecessary movement when switching focus or sharing between multiple shared documents.

For example, it can be advantageous for the first participant (e.g., the presenter) to view two or more selected documents for display without toggling display of the selected applications or application windows to the one or more second participants, such as to provide better control of transitions, to reduce unwanted or unnecessary transitions, or to provide additional information security in not sharing sensitive or mistakenly selected applications or application windows. If the first application 421 completely overlaps the second application 422, the available mechanisms for the first participant to switch between causing the first or second applications 421, 422 are reduced, and may require minimizing, resiting, or dragging one or more of the first or second applications 421, 422 instead of mere selection or interaction of an item visible to the first participant. In addition, it can be further advantageous to the one or more second participants (e.g., an audience) to reduce unwanted or unnecessary transitions or switches between shared applications or application windows by the first participant (e.g., the presenter).

In addition, as available screen sizes and configurations continue to increase, as well as mobile or distributed work, participants may be more likely to view a presentation from a mobile device or from a device having different screen proportions than the presenter. In certain examples, the presenter may be more likely to share applications or application windows from a desktop computer, laptop, or conference system having a larger graphical user interface. Sharing applications or application windows in the proportions or numbers displayed to the presenter may be detrimental to participants, who may not have the same available screen size or proportions, providing situations where the material being presented is at a size unreadable to the one or more second participants without additional control or manipulation of the display by one or more second participants. It can be advantageous to provide only one of multiple shared applications or applications windows to be displayed at a time, such as to increase the likelihood that all participants can view the presented material, and can reduce otherwise unnecessary manipulation of the display by the one or more second participants.

Existing meeting applications include procedures to transition sharing from a first document, such as the first application 421, to a second document, such as the second application 422. In one prior art meeting application, the share must be adjusted, such as by ending sharing of the first document and starting a new share with the second document. Switching back to the first document again would require ending sharing of the second document and starting a new share with the first document. Each transition takes time, multiple clicks, and multiple transitions to the meeting application view of both first and second participants, as the transition further includes a different share, typically representations of the meeting participants, between ending a first share and starting a second. When discussing multiple documents in a unified communication session, these multiple shares between different applications or application windows (e.g., of the same or different applications) can be burdensome, time consuming, and visually unappealing. Additionally, each transition of sharing mode, between the documents and the representations of the meeting participants, provides additionally opportunities for the meeting application to freeze or fail.

In a second prior art meeting application, multiple applications can be shared, but all selected applications are shared if visible on the topmost or foreground view of the graphical user interface of the first user device. If multiple application windows of a respective application are active or open on the first user device, the windows visible at the topmost or foreground view of the graphical user interface will be displayed to participants. Sensitive documents inadvertently brought to the topmost or foreground view of the graphical user interface will be shared if that application has been selected for sharing—as all application windows of that application will be shared if visible to the presenter. Additionally, transitioning between sharing just one application window at a time would require minimizing and maximizing respective application windows, such that the new share would not be visible to the presenter until it is shared with participants, or dragging application windows to an unshared screen or portion thereof, or re-positioning desired application window to be shared entirely over an application window that is not desired to be shared, all in view of the participants.

Accordingly, the second participant meeting application view 400B includes a representation of the first application 421 and not the second application 422, even though the second application 422 is visible on the first participant meeting application view 400A. The second participant meeting application view 400B optionally includes a representation of a first user 403 (e.g., the first participant, the presenter, etc.). In other examples, one or more of the first and second participant meeting application views 400A, 400B can include shared representations of one or more other participants in various combinations or configurations.

To switch between causing the first application 421 to be displayed at the second participant meeting application view 400B, the presenter can select or interact with the second application 422 on the first user device, such as using the pointer 425 or one or more other commands (e.g., an application window switcher, alt+tab, etc.) or interactions with a graphical user interface or user input of the first user device (e.g., touch screen selection, etc.).

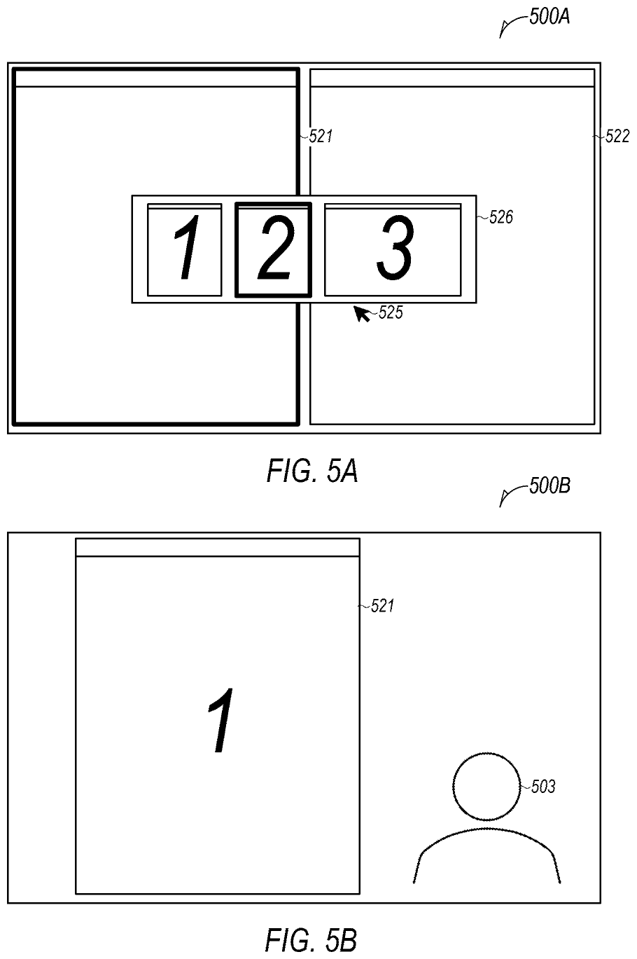

FIGS. 5A and 5B illustrate example first and second participant meeting application views 500A, 500B of a unified communication session, including a first participant meeting application view 500A, such as that of a presenter on a first user device, and a second participant meeting application view 500B, such as that of an audience on a second user device.

The first participant meeting application view 500A includes a topmost or foreground view of the graphical user interface of the first user device of the first participant, including two applications selected for display to one or more second participants, first and second applications (or application windows) 521, 522 respectively, a pointer 525, and an application window switcher 526, such as activated by a keyboard command (e.g., alt+tab, etc.). Activating the application window switcher 526 can prompt display of open applications or applications windows on the first user device, such as in a z-order sequence, initially highlighting the second application in the z-order sequence, in this example the second application 522, as the highest position in the z-order sequence is the currently displayed application. The application window switcher 526 additionally can include other open applications or application windows, such as a third application or application window, etc.

While the application window switcher 526 is open, the second participant meeting application view 500B continues to display the first application 521. When a different selected application or application window is selected or interacted with, such as by selection with the pointer 525 or through the application window switcher 526, the second participant meeting application view 500B can transition to the different selected application or application window. If an unselected application or application window is selected or interacted with, such as an unselected third application or application window, the second participant meeting application view 500B can continue to display the first application 521, and may not change to the unselected application or application window or otherwise alter the display.

The second participant meeting application view 500B optionally includes a representation of a first user 503 (e.g., the first participant, the presenter, etc.). In other examples, one or more of the first and second participant meeting application views 500A, 500B can include shared representations of one or more other participants in various combinations or configurations.

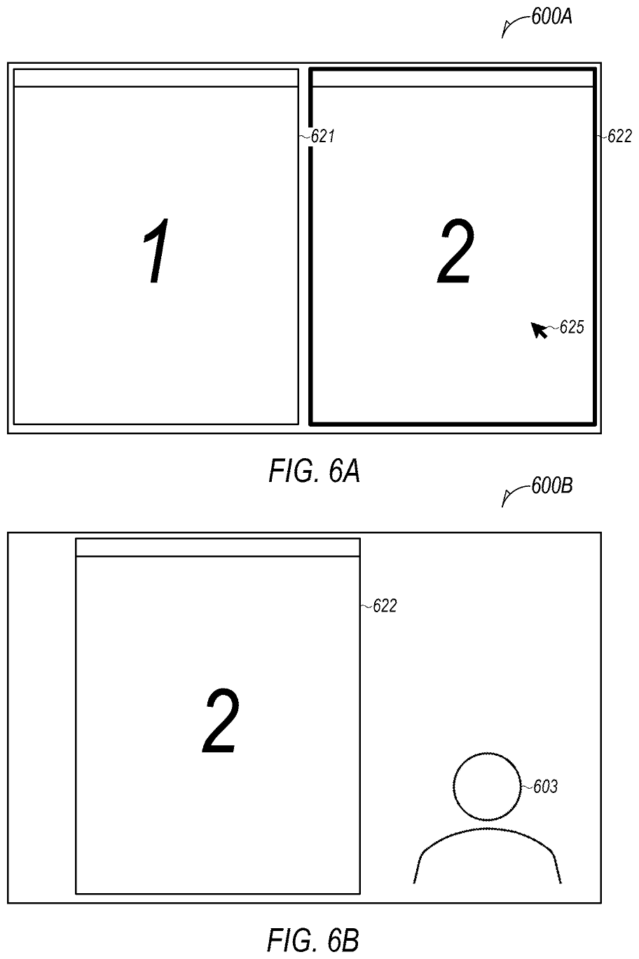

FIGS. 6A and 6B illustrate example first and second participant meeting application views 600A, 600B of a unified communication session, including a first participant meeting application view 600A, such as that of a presenter on a first user device, and a second participant meeting application view 600B, such as that of an audience on a second user device.

The first participant meeting application view 600A includes two applications selected for display to one or more second participants, first and second applications (or application windows) 621, 622 respectively, and a pointer 625. The second application 622 is highlighted on the first participant meeting application view 600A as the currently displayed application on the second participant meeting application view 600B.

The second participant meeting application view 600B includes a representation of the second application 622 and not the first application 621, even though the first application 621 is visible on the first participant meeting application view 600A. The second participant meeting application view 600B optionally includes a representation of a first user 603 (e.g., the first participant, the presenter, etc.). In other examples, one or more of the first and second participant meeting application views 600A, 600B can include shared representations of one or more other participants in various combinations or configurations.

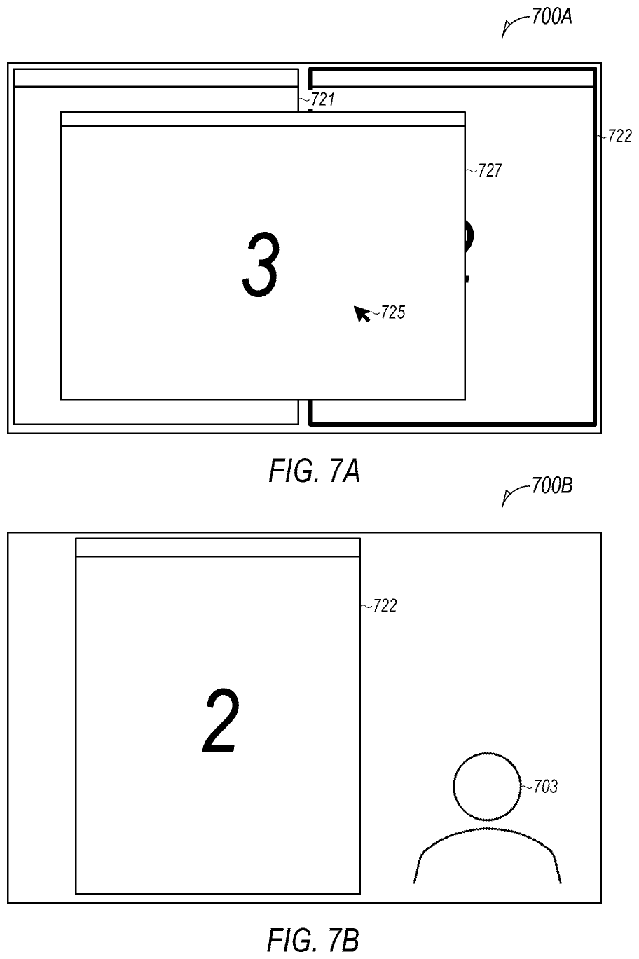

FIGS. 7A and 7B illustrate example first and second participant meeting application views 700A, 700B of a unified communication session, including a first participant meeting application view 700A, such as that of a presenter on a first user device, and a second participant meeting application view 700B, such as that of an audience on a second user device.

The first participant meeting application view 700A includes two applications selected for display to one or more second participants, first and second applications (or application windows) 721, 722 respectively, an unselected third application (or application window) 727 not selected for display, and a pointer 725. The second application 722 is highlighted on the first participant meeting application view 700A as the currently displayed application on the second participant meeting application view 700B. In certain examples, navigation to, selection of, or the otherwise appearance of an unselected application or application window in front of a selected application, such as the first or second applications 721, 722, etc., will not change or alter the display at the second participant meeting application view 700B. In this way, pop-ups, notifications, email messages, advertisements, an application window switcher, or other randomly appearing or user selected windows will not interfere with the display at the second participant meeting application view 700B. Additionally, the presenter can have more control over the information shared during the unified communication session, as well as be able to navigate to one or more additional sources or look up information during sharing without impacting the displayed material to the one or more second participants.

The second participant meeting application view 700B includes a representation of the second application 722 and not the first application 721 or the third application 727, even though the first application 721 is visible on the first participant meeting application view 700A and the third application 727 is visible on the first participant meeting application view 700A and over the second application 722 at the topmost or forefront view of the first user device. The second participant meeting application view 700B optionally includes a representation of a first user 703 (e.g., the first participant, the presenter, etc.). In other examples, one or more of the first and second participant meeting application views 700A, 700B can include shared representations of one or more other participants in various combinations or configurations.

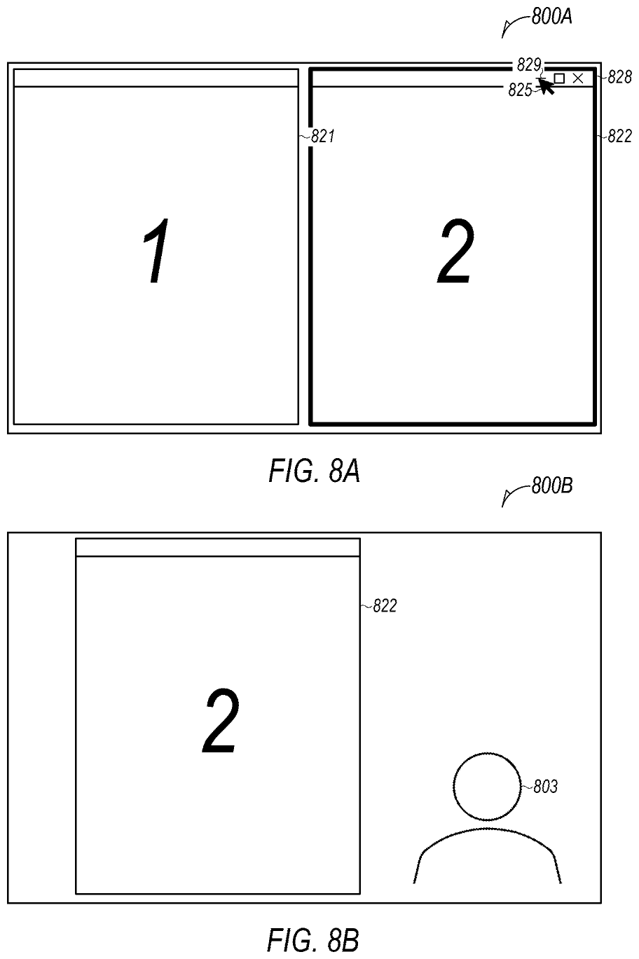

FIGS. 8A and 8B illustrate example first and second participant meeting application views 800A, 800B of a unified communication session, including a first participant meeting application view 800A, such as that of a presenter on a first user device, and a second participant meeting application view 800B, such as that of an audience on a second user device.

The first participant meeting application view 800A includes two applications selected for display to one or more second participants, first and second applications (or application windows) 821, 822 respectively, and a pointer 825. The second application 822 is highlighted on the first participant meeting application view 800A as the currently displayed application on the second participant meeting application view 800B.

The second participant meeting application view 800B includes a representation of the second application 822 and not the first application 821, even though the first application 821 is visible on the first participant meeting application view 800A. The second participant meeting application view 800B optionally includes a representation of a first user 803 (e.g., the first participant, the presenter, etc.). In other examples, one or more of the first and second participant meeting application views 800A, 800B can include shared representations of one or more other participants in various combinations or configurations.

The second application 822 on the first participant meeting application view 800A includes a title bar 828 having one or more controls, including a minimize control 829. Selection of the minimize control 829, such as through the pointer 825 or other keyboard command or user interaction, can minimize the second application 822 on the first participant meeting application view 800A and stop display of the second application 822 on the second participant meeting application view 800B, in certain examples, switching to another active shared application or application window. If no other active shared application or application window is available at the first user device, a blank or placeholder screen can be displayed until one or more shared application or application windows are brought to a visible or active state on the first user device. In some examples, if no other active shared application or application window is available at the first user device, the first user device can stop sharing automatically. In certain examples, a copy of the last share is not held static at the second participant meeting application view 800B, such as to increase data privacy for the presenter and reduce the amount of data shared in the unified communication session.

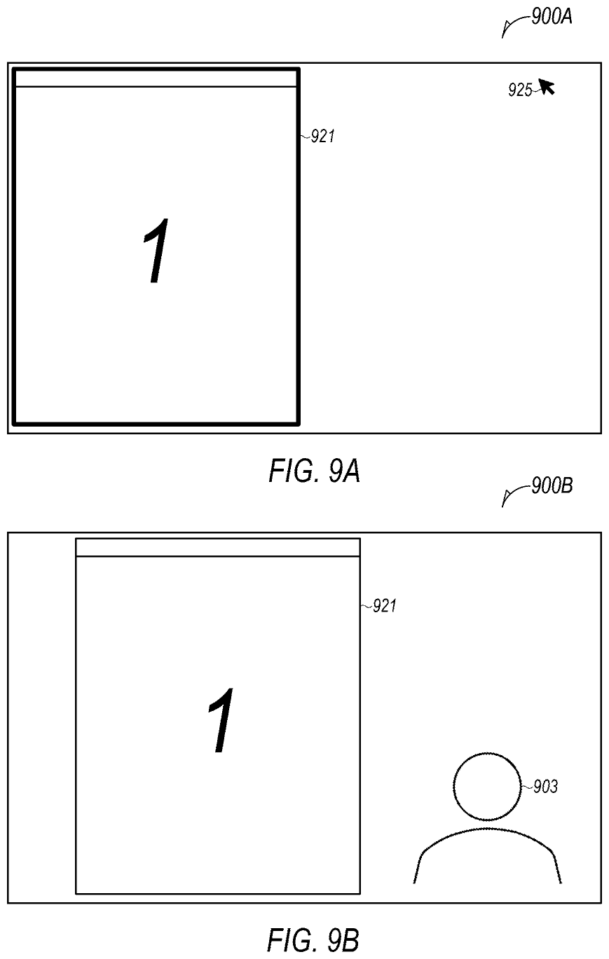

FIGS. 9A and 9B illustrate example first and second participant meeting application views 900A, 900B of a unified communication session, including a first participant meeting application view 900A, such as that of a presenter on a first user device, and a second participant meeting application view 900B, such as that of an audience on a second user device.

The first participant meeting application view 900A includes a first application (or application window) 921 selected for display to one or more second participants and a pointer 925. The first application 921 is highlighted on the first participant meeting application view 900A as the currently displayed application on the second participant meeting application view 900B, such as after minimizing or closing a second application (see FIGS. 8A-8B, etc.).

The second participant meeting application view 900B includes a representation of the first application 921 and optionally a representation of a first user 903 (e.g., the first participant, the presenter, etc.). In other examples, one or more of the first and second participant meeting application views 900A, 900B can include shared representations of one or more other participants in various combinations or configurations.

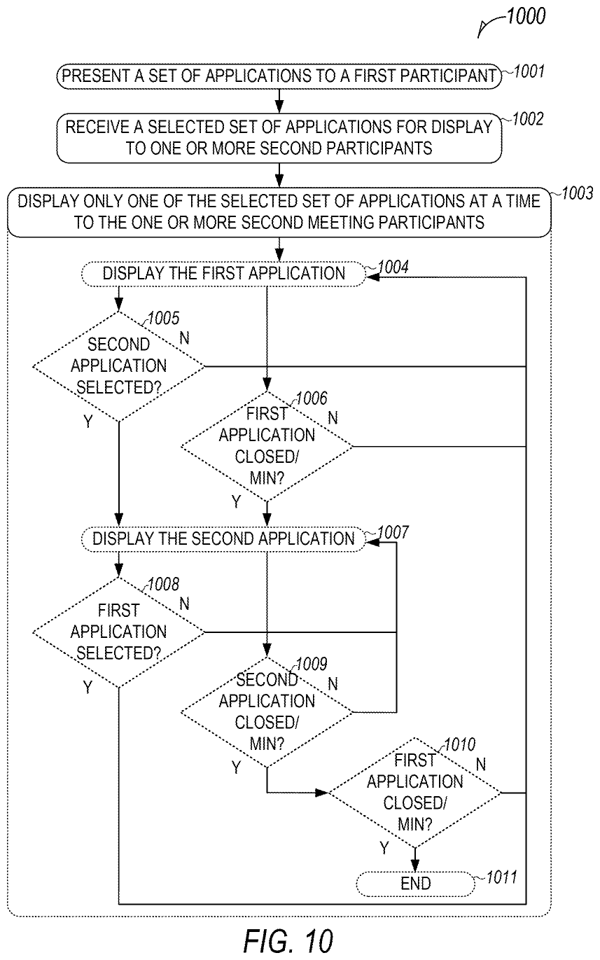

FIG. 10 illustrates an example method 1000 of managing presentation of multiple applications (e.g., two or more) from a first participant to one or more second participants of a unified communication session, such as described herein. Although described herein as managing sharing of multiple applications, in certain examples, although initially selected as sharing multiple applications, the multiple applications or application windows can be reduced after sharing to a single application or application window, or in certain examples, from multiple (e.g., two or more) to no active shares, and then increased (e.g., such as by maximizing a previously minimized or closed application or application window) back to one or multiple shares.

At step 1001, a selectable set of applications can be presented to the first participant of the unified communication session, such as through a meeting application executed on a first user device prior to sharing one or more of the multiple applications from the first participant of the unified communication session to the one or more second participants. As described herein, in certain examples, the selectable set of applications can include a selectable set of application windows, in certain examples nested via selection underneath the selectable set of applications, or presented individually.

At step 1002, a selected set of applications (or application windows) of the multiple applications can be received for display to the one or more second participants during the unified communication session, such as through the meeting application in response to presenting the selectable set of applications to the first participant. In an example, the selected set of applications can include a selected subset (e.g., less than all) of the selectable set of applications. In other examples, the selected set of applications can include all of the selectable set of applications (e.g., in situations where all are desired to be shared, or all only includes a small number of applications, such as one, two, or three applications or application windows, etc.). In certain examples, the selected set of applications can include a first application and a second application.

At step 1003, only one of the selected set of applications (or application windows) can be displayed at a time to the one or more second meeting participants, such as through respective meeting applications executed on respective user devices of the one or more second meeting participants. In an example, a meeting service coupled to respective meeting applications can cause the respective meeting applications to display only one of the selected set of applications at a time to the one or more second meeting participants. Switching between the selected set of applications (or application windows) can be controlled at the respective meeting applications of the one or more second meeting participants through the meeting service based on a most recent selection or user interaction with the selected set of applications through a first user input of the first user device.

In certain examples, switching between fully overlapping applications as displayed on the graphical user interface of the first user device can be prohibited, or can be outside the scope of the switching described herein, as such switching cannot be made as securely than if both of the multiple applications or application windows involved in the switching are visible to the first participant during the process of switching between the multiple applications or application windows. If two applications are selected and one is fully overlapping, the fully overlapped application can be required to be placed in an active state (e.g., non-minimized, or at least partially visible at the topmost or foreground view of the graphical user interface of the first user device), or a separate confirmation of switching can be presented to the first participant before switching to display of the fully overlapping application. In certain examples, if one of the multiple windows was not visible (e.g., minimized, covered, etc.), it can be required to be made visible or at least partially visible at the topmost or foreground view of the graphical user interface of the first user device and then selected or interacted with to be displayed to the one or more second participants.

In certain examples, step 1003 optionally includes one or more of steps 1004 through 1010. Although described in steps 1004 through 1011 with respect to the first and second applications, in other examples, the selected set of applications can include more applications or application windows (e.g., three or more, etc.), and switching between the selected set of applications can include switching between more than the most recent two applications.

At step 1004, after receiving the selected set of applications including the first and second applications, such as through a meeting application on a first user device of the first participant, the first application (or application window) can be displayed to the one or more second participants. In an example, displaying the first application can include causing the first application to be displayed, such as by a meeting application of the one or more second participants connected to a meeting service.

If, at step 1005, the second application is selected or otherwise interacted with or navigated to by the first participant on the first user device, the second application (or application window) can be displayed to the one or more second participants at step 1007. If, at step 1005, the second application is not selected or otherwise interacted with or navigated to, the method can return to step 1004.

If, at step 1006, the first application is closed or minimized, such as by the first participant on the first user device, the second application (or application window) can be displayed to the one or more second participants at step 1007. If, at step 1006, the first application is not closed or minimized, the method can return to step 1004.

At step 1007, the second application (or application window) can be displayed to the one or more second participants. In an example, displaying the second application can include causing the second application to be displayed, such as by the meeting application of the one or more second participants connected to the meeting service.

If, at step 1008, the first application is selected or otherwise interacted with or navigated to by the first participant on the first user device, the first application (or application window) can be displayed to the one or more second participants at step 1004. If, at step 1008, the first application is not selected or otherwise interacted with or navigated to, the method can return to step 1007.

If, at step 1009, the second application is closed or minimized, such as by the first participant on the first user device, the method proceeds to step 1010. If, at step 1009, the second application is not closed or minimized, the method can return to step 1007.

If, at step 1010, the first application is closed or minimized, and there are no other active or visible application (or application window) of the selected set of applications, the method of managing presentation of multiple applications can end at step 1011. If, at step 1010, the first application is not closed or minimized, the method can return to step 1004.

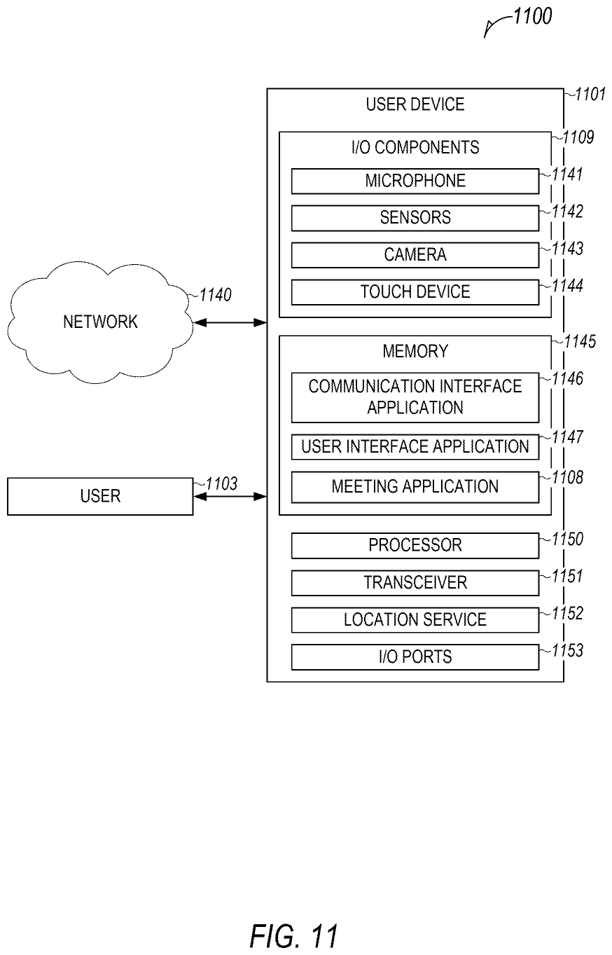

FIG. 11 illustrates an example system 1100 including a user device 1101 having one or more I/O components 1109, a memory 1145, a processor 1150, a transceiver 1151, a location service component 1152, and one or more I/O ports 1153. The user device 1101 can take the form of a mobile computing device or any other portable device, such as a mobile telephone, laptop, tablet, computing pad, notebook, gaming device, portable media player, etc. In other examples, the user device 1101 can include a less portable device, such as desktop personal computer, kiosk, tabletop device, industrial control device, etc. Other examples can incorporate the user device 1101 as part of a multi-device system in which two separate physical devices share or otherwise provide access to the illustrated components of the user device 1101.

The processor 1150 can include any quantity of processing units and is programmed to execute computer-executable instructions for implementing aspects of the disclosure. The instructions may be performed by the processor or by multiple processors within the computing device or performed by a processor external to the user device 1101. In some examples, the processor 1150 is programmed to execute methods, such as the one or more method illustrated herein, etc. Additionally, or alternatively, the processor 1150 can be programmed to present an experience in a user interface (“UI”), such as the user interface illustrated in FIGS. 2-9, etc. In certain examples, the processor 1150 can represent an implementation of techniques to perform the operations described herein.

The transceiver 1151 can include an antenna capable of transmitting and receiving radio frequency (“RF”) signals and various antenna and corresponding chipsets to provide communicative capabilities between the user device 1101 and one or more other remote devices. Examples are not limited to RF signaling, however, as various other communication modalities may alternatively be used.

The I/O components 1109 can include, without limitation, computer monitors, televisions, projectors, touch screens, phone displays, tablet displays, wearable device screens, televisions, speakers, vibrating devices, and any other devices configured to display, verbally communicate, or otherwise provide information visibly or audibly to a user 1103 on the user device 1101. For example, the user device 1101 can include a desktop computer, a laptop computer, a smart phone, or a mobile tablet including speakers capable of displaying images or playing audio to the user 1103. In other examples, the user device 1101 can include a computer in a car that plays audio to the user 1103 through a car speaker system, visually presents images on a display screens (e.g., situated in the car's dashboard, within headrests, on a drop-down screen, etc.), or combinations thereof. Other examples present the disclosed presentation material through various other display or audio I/O components 1109.

The I/O components 1109 can include one or more of a microphone 1141, one or more sensors 1142, a camera 1143, or a touch device 1144. The microphone 1141 can capture speech from, by, about, or near the user 1103. The sensors 1142 can include any number of sensors on or in a mobile computing device, electronic toy, gaming console, wearable device, television, vehicle, or the user device 1101, such as one or more of an accelerometer, magnetometer, pressure sensor, photometer, thermometer, global positioning system (“GPS”) chip or circuitry, bar scanner, biometric scanner for scanning fingerprint, palm print, blood, eye, or the like, gyroscope, near-field communication (“NFC”) receiver, or any other sensor configured to capture data from the user 1103 or the environment. The camera 1143 can capture images or video of or by the user 1103. The touch device 1144 can include a touchpad, track pad, touch screen, or other touch-capturing device. In other examples, the I/O components 1109 can include one or more of a sound card, a vibrating device, a scanner, a printer, a wireless communication module, or any other component for capturing information related to the user 1103 or the environment. In contrast, the I/O ports 1153 allow the user device 1101 to be logically coupled to other devices and I/O components 1109, some of which may be built into user device 1101 while others may be external.

The memory 1145 can include any quantity of memory associated with or accessible by the user device 1101. The memory 1145 can be internal to the user device 1101, external to the user device 1101, or a combination thereof. The memory 1145 can include, without limitation, random access memory (RAM), read only memory (ROM), electronically erasable programmable read only memory (EEPROM), flash memory or other memory technologies, CDROM, digital versatile disks (DVDs) or other optical or holographic media, magnetic cassettes, magnetic tape, magnetic disk storage or other magnetic storage devices, memory wired into an analog computing device, or any other medium for encoding desired information and for access by the user device 1101. The terms computer-readable medium, machine readable medium, and storage device do not include carrier waves to the extent carrier waves are deemed too transitory. The memory 1145 can take the form of volatile and/or nonvolatile memory, can be removable, non-removable, or a combination thereof; and can include various hardware devices, such as solid-state memory, hard drives, optical-disc drives, etc. Additionally, or alternatively, the memory 1145 can be distributed across multiple user devices, such as the user device 1101, such as in a virtualized environment in which instruction processing is carried out on multiple ones of the user device 1101. The memory 1145 can store, among other data, various device applications that, when executed by the processor 1150, operate to perform functionality on the user device 1101. Example applications can include search applications, instant messaging applications, electronic-mail application programs, web browsers, calendar application programs, address book application programs, messaging programs, media applications, location-based services, search programs, and the like. The applications may communicate with counterpart applications or services such as web services accessible via the network 1140. For example, the applications can include client-operating applications that correspond to server-side applications executing on remote servers or computing devices in the cloud.

Instructions stored in the memory 1145 can include, among other things, one or more of a communication interface application 1146, a user interface application 1147, and a meeting application 1108. The communication interface application 1146 can include one or more of computer-executable instructions for operating a network interface card and a driver for operating the network interface card. Communication between the user device 1101 and other devices can occur using any protocol or mechanism over a wired or wireless connection or across the network 1140. In some examples, the communication interface application 1146 is operable with RF and short-range communication technologies using electronic tags, such as NFC tags, Bluetooth® brand tags, etc.

In some examples, the user interface application 1147 includes a graphics application for displaying data to the user and receiving data from the user. The user interface application 1147 can include computer-executable instructions for operating the graphics card to display search results and corresponding images or speech on or through one or more of the I/O components 1109. The user interface application 1147 can interact with the various sensors 1142 and camera 1143 to both capture and present information through the I/O components 1109.

The location service component 1152 can be configured to receive information from one or more of the sensors 1142 or transceiver 1151 and to determine a physical location of the user device 1101. In certain examples, the location service component 1152 can receive or determine the physical location using information from one or more wireless networks, including wired or wireless, long- or short-range communication access points, etc., using information from one or more GPS chip or circuitry, or combinations thereof.

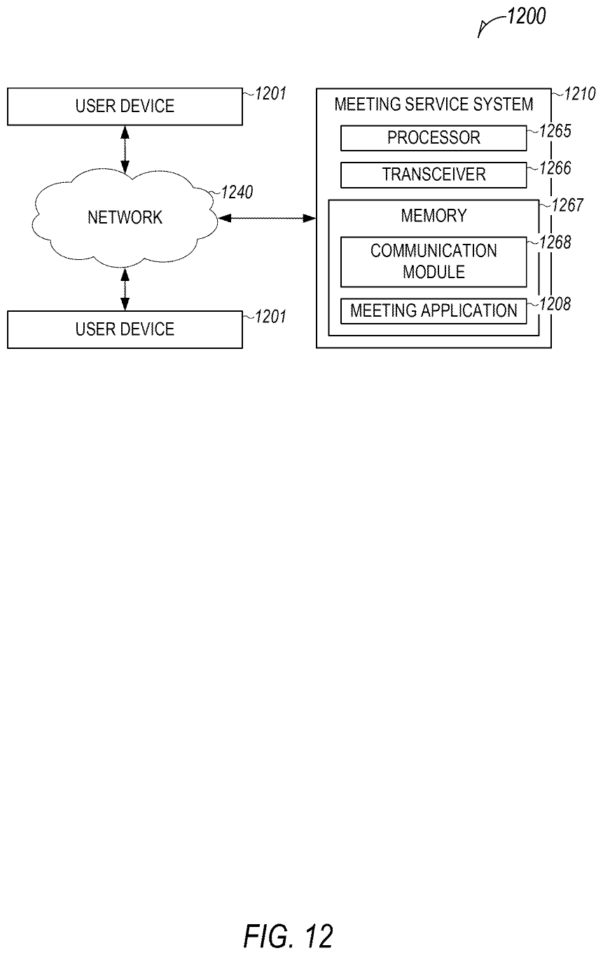

FIG. 12 illustrates an example networking environment 1200 including one or more user devices, such as first and second user devices 1201, 1202 and a meeting service system 1210 communicating over a network 1240. In some examples, interaction between one or more of the components described herein, such as between meeting applications of respective user devices, can be managed over the network 1240 by the meeting service system 1210. In certain examples, the meeting service system 1210 can facilitate unified communication sessions, including sharing of multiple applications from a first participant to one or more second participants.

The networking environment 1200 illustrated in FIG. 12 is an example of one suitable computing system environment and is not intended to suggest any limitation as to the scope of use or functionality of examples disclosed herein. The illustrated networking environment 1200 should not be interpreted as having any dependency or requirement related to any single component, module, index, or combination thereof, and in other examples, other network environments are contemplated.

The network 1240 can include the internet, a private network, a local area network (LAN), a wide area network (WAN), or any other computer network, including various network interfaces, adapters, modems, and other networking devices for communicatively connecting the user devices and the meeting service system 1210. The network 1240 can also include configurations for point-to-point connections.

The first and second user devices 1201, 1202 include any type of user device discussed herein. Each user device can capture user or environment data from their respective users and communicate the captured user and environment data over the network 1240 to the meeting service system 1210, such as using a communication module or transceiver, as discussed herein. In response, a communication module 1268 of the meeting service system 1210 can be capable of providing and receiving messages including images, videos, audio, text, and other various communication media to and from the user devices over the network 1240.

The first and second user devices 1201, 1202 can include various software applications and presentation components for communicating via a message thread associated with respective unified communication sessions attended by users of the first and second user devices 1201, 1202. For example, a mobile phone can display a meeting application (e.g., Microsoft Teams application) for communicating with other attendees of a virtual or hybrid meeting.

The meeting service system 1210 can include a server or collection of servers configured to execute different web-service computer-executable instructions. The meeting service system 1210 includes a processor 1265 to process executable instructions, a transceiver 1266 to communicate over the network 1240, and a memory 1267 embodied with at least the following executable instructions: a communication module 1268, a meeting application 1208, or one or more other modules, such as a roster module, an image recognition module, or one or more other modules, etc. While the communication module 1268 is illustrated as a single box, it is not so limited, and can be scalable. For example, the communication module 1268 can include multiple servers operating various portions of software that collectively manage a hybrid meeting environment.

The first and second user devices 1201, 1202 can provide information about one or more users, such as a user profile, accessible over the network 1240 by the meeting service system 1210 to assist in providing services to the one or more user devices. Herein, a “user profile” refers to an electronically stored collection of information related to the user. Such information can be stored based on a user's explicit agreement or “opt-in” to having such personal information be stored, the information including the user's name, age, gender, height, weight, demographics, current location, residency, citizenship, family, friends, schooling, occupation, hobbies, skills, interests, Web searches, health information, birthday, anniversary, celebrated holidays, moods, user condition, and any other personalized information associated with the user, including biometric information. The user profile includes static profile elements (e.g., name, birthplace, etc.), and dynamic profile elements that change over time (e.g., residency, age, condition, etc.). The user profile can be built through probing questions to the user or through analyzing user behavior on one or more user devices.

The present disclosure relates to systems and methods for managing in-room meeting participants of a hybrid meeting according to at least the examples provided in the sections below:

(A1) In one aspect, some embodiments or examples include a method of managing presentation of multiple applications from a first participant to one or more second participants of a unified communication session, comprising: prior to sharing one or more of the multiple applications from the first participant of the unified communication session to the one or more second participants, presenting a set of applications to the first participant of the unified communication session through a meeting application executed on a first user device; in response to presenting the set of applications to the first participant, receiving a selected set of applications of the multiple applications for display to the one or more second participants during the unified communication session, the selected set of applications including a first application and a second application; and causing only one of the selected set of applications to be displayed at a time to the one or more second participants through the meeting application, including: switching between causing the first application to be displayed and causing the second application to be displayed to the one or more second participants based on a most recent selection or user interaction through a first user input with the first and second applications, wherein the first and second applications are not fully overlapping on a graphical user interface of the first user device.

(A2) In some embodiments of A1, causing only one of the first application or the second application to be displayed at a time includes causing only one of the first application or the second application to be displayed to the one or more second participants through the meeting application while the first application and the second application are separate, substantially non-overlapping windows in an active state on a desktop of the graphical user interface of the first user device.

(A3) In some embodiments of A1-A2, causing only one of the first application or the second application to be displayed at a time includes: causing the first application, and not the second application, to be displayed to the one or more second participants through the meeting application at a first time; receiving a selection or user interaction through the first user input of the second application, transitioning from the first time to a second time; and responsive to receiving the selection or user interaction of the second application, causing the second application, and not the first application, to be displayed to the one or more second participants through the meeting application at the second time,

(A4) In some embodiments of A1-A3, switching between causing the first application to be displayed and causing the second application to be displayed includes transitioning from the first time to the second time based on receiving the selection or user interaction through the first user input with the second application.

(A5) In some embodiments of A1-A4, causing only one of the first application or the second application to be displayed at a time includes: causing the second application, and not the first application, to be displayed to the one or more second participants through the meeting application at a second time; receiving a selection or user interaction through the first user input of the first application, transitioning from the second time to a first time; and responsive to receiving the selection or user interaction of the first application, causing the first application, and not the second application, to be displayed to the one or more second participants through the meeting application at the first time.

(A6) In some embodiments of A1-A5, switching between causing the first application to be displayed and causing the second application to be displayed includes transitioning from the second time to the first time based on receiving the selection or user interaction through the first user input with the first application.

(A7) In some embodiments of A1-A6, causing only one of the first application or the second application to be displayed at a time includes restricting display of an unselected application of the set of applications and restricting interference of the unselected application with the display of the first and second applications, including maintaining display of the first application or the second application in response to a selection or user interaction with the unselected application through the first user input.

(A8) In some embodiments of A1-A7, the set of applications include a set of active applications on the first user device, and the first and second applications are separate first and second application windows of the same application executed on the first user device.

(A9) In some embodiments of A1-A8, the first application includes one or more application windows of the first application executed on the first user device, the second application includes one or more application windows of the second application executed on the first user device, and the first and second applications are different applications executed on the first user device.

(A10) In some embodiments of A1-A9, the most recent selection includes the first or second application having a higher z-order on the first user device and in an active and non-minimized state, or the most recent user interaction includes the first or second application navigated to, having an active cursor in, or selected using the first user input, without minimizing the first or second applications.

In yet another aspect, some embodiments include a system including a processor and a memory device coupled to the processor and having a program stored thereon for execution by the processor to perform operations comprising any of the embodiments of A1-A10 described above in various combinations or permutations. In yet another aspect, some embodiments include a non-transitory computer-readable storage medium storing one or more programs for execution by one or more processors of a storage device, the one or more programs including instructions for performing any of the embodiments of A1-A10 described above in various combinations or permutations. In yet another aspect, some embodiments include a method or a system including means for performing any of the embodiments of A1-A10 described above in various combinations or permutations.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

In the description herein, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized, and that structural, logical, and electrical changes may be made without departing from the scope of the present invention. The included description of example embodiments is, therefore, not to be taken in a limited sense, and the scope of the present invention is defined by the appended claims.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, hard disk, floppy disk, magnetic strips, optical disk, compact disk (CD), digital versatile disk (DVD), smart cards, flash memory devices, among others. In contrast, computer-readable media (i.e., not storage media) may additionally include communication media such as transmission media for wireless signals and the like.

1. A method of managing presentation of multiple applications from a first participant to one or more second participants of a unified communication session, comprising:
prior to sharing one or more of the multiple applications from the first participant of the unified communication session to the one or more second participants, presenting a set of applications to the first participant of the unified communication session through a meeting application executed on a first user device;
in response to presenting the set of applications to the first participant and prior to sharing the one or more of the multiple applications, receiving a selected set of applications of the multiple applications for display to the one or more second participants during the unified communication session, the selected set of applications including a first application and a second application;
receiving individual permissions for the one or more second participants to view the one or more of the selected set of applications during the unified communication session; and
causing only one of the selected set of applications to be displayed at a time to the one or more second participants having individual permission to view the one of the selected set of applications through the meeting application during the unified communication session based on a most recent selection or user interaction through a first user input with the with the selected set of applications.

2.-8. (canceled)

9. A system for managing presentation of multiple applications from a first participant to one or more second participants of a unified communication session, comprising:
one or more processors; and
a memory storing computer-executable instructions that, when executed, cause the one or more processors to control the system to perform operations comprising:
prior to sharing one or more of the multiple applications from the first participant of the unified communication session to the one or more second participants, presenting a set of applications to the first participant of the unified communication session through a meeting application executed on a first user device;
in response to presenting the set of applications to the first participant and prior to sharing the one or more of the multiple applications, receiving a selected set of applications of the multiple applications for display to the one or more second participants during the unified communication session, the selected set of applications including a first application and a second application;
receiving individual permissions for the one or more second participants to view the one or more of the selected set of applications during the unified communication session; and
causing only one of the selected set of applications to be displayed at a time to the one or more second participants having individual permission to view the one of the selected set of applications through the meeting application during the unified communication session based on a most recent selection or user interaction through a first user input with the with the selected set of applications.

10.-16. (canceled)

17. A system for managing presentation of multiple applications from a first participant to one or more second participants of a unified communication session, comprising:
one or more processors; and
a memory storing computer-executable instructions that, when executed, cause the one or more processors to control the system to perform operations comprising:
presenting a set of applications to the first participant of the unified communication session through a meeting application executed on a first user device;
receiving a selected set of applications of the multiple applications for display to the one or more second participants during the unified communication session, the selected set of applications including a first application and a second application; and
causing only one of the selected set of applications to be displayed at a time to the one or more second participants having individual permission to view the one of the selected set of applications through the meeting application during the unified communication session based on a most recent selection or user interaction through a first user input with the with the selected set of applications.

18.-20. (canceled)

21. The method of claim 1, comprising:
prior to sharing one or more of the multiple applications from the first participant of the unified communication session to the one or more second participants, presenting the one or more second participants to the first participant of the unified communication session through the meeting application executed on the first user device,
wherein receiving individual permissions comprise, in response to presenting the one or more second participants to the first participant and prior to sharing the one or more of the multiple applications, receiving individual permissions from the first participant for the one or more second participants to view the one or more of the selected set of applications during the unified communication session.

22. The method of claim 1, wherein presenting the set of applications to the first participant of the unified communication session comprises presenting a set of active applications executed on the first user device to the first participant of the unified communication session, each of the active applications including at least one active application window executed on the first user device,
wherein receiving the selected set of applications comprises receiving a single selected set of active applications of the multiple applications for display to the one or more second participants during the unified communication session,
wherein causing only one of the selected set of applications to be displayed at a time comprises causing only one of the selected set of active applications to be displayed at a time, and
wherein unselected and inactive applications of the set of applications will not be displayed to the one or more second participants through the meeting application.

23. The method of claim 1, wherein causing only one of the selected set of applications to be displayed at a time to the one or more second participants having individual permission to view the one of the selected set of applications through the meeting application comprises causing only active applications to be displayed, wherein active applications exclude minimized applications, wherein causing a minimized application to be displayed is restricted.

24. The method of claim 1, wherein the one or more second participants comprises a second user and a third user,
wherein receiving individual permissions for the one or more users comprises receiving individual permissions for the second user for the first application and the second application and receiving individual permissions for the third user for the first application and the second application.

25. The method of claim 24, wherein receiving individual permissions for the second and third users comprises receiving individual permission for the second user to view the first and second applications and receiving individual permission for the third user to view the first application but not the second application, and
wherein causing only one of the selected set of applications to be displayed at a time to the one or more second participants having individual permission to view the one of the selected set of applications through the meeting application during the unified communication comprises:
causing only one of the first application or the second application to be displayed at a time to the second participant session based on a most recent selection or user interaction through the first user input with the with the first and second applications; and
causing only the first application and not the second application to be displayed to the third participant.

26. The method of claim 1, wherein receiving individual permissions comprises receiving a profile-based permission from the first participant and determining individual permissions for the one or more second participants based on profile information for the individual one or more second participants and the received profile-based permission.

27. The method of claim 26, wherein the profile-based permission includes at least one of an organization or a specific group within an organization, and
wherein determining the individual permissions comprises providing permission for the one or more second participants within the organization or within the specific group of the organization.

28. The method of claim 26, wherein the profile-based permission includes a registration status for the unified communication session, wherein the registration status comprises one of registered and not registered, and
wherein determining the individual permissions comprises providing permission for the one or more second participants registered for the unified communication session.

29. The method of claim 1, wherein the first and second applications include different first and second application windows of the same application, and
wherein the first and second applications are not fully overlapping on a graphical user interface of the first user device.

30. The system of claim 9, wherein the operations comprise:
prior to sharing one or more of the multiple applications from the first participant of the unified communication session to the one or more second participants, presenting the one or more second participants to the first participant of the unified communication session through the meeting application executed on the first user device,
wherein receiving individual permissions comprise, in response to presenting the one or more second participants to the first participant and prior to sharing the one or more of the multiple applications, receiving individual permissions from the first participant for the one or more second participants to view the one or more of the selected set of applications during the unified communication session.

31. The system of claim 9, wherein presenting the set of applications to the first participant of the unified communication session comprises presenting a set of active applications executed on the first user device to the first participant of the unified communication session, each of the active applications including at least one active application window executed on the first user device,
wherein receiving the selected set of applications comprises receiving a single selected set of active applications of the multiple applications for display to the one or more second participants during the unified communication session,
wherein causing only one of the selected set of applications to be displayed at a time comprises causing only one of the selected set of active applications to be displayed at a time, and
wherein unselected and inactive applications of the set of applications will not be displayed to the one or more second participants through the meeting application.

32. The system of claim 9, wherein causing only one of the selected set of applications to be displayed at a time to the one or more second participants having individual permission to view the one of the selected set of applications through the meeting application comprises causing only active applications to be displayed, wherein active applications exclude minimized applications, wherein causing a minimized application to be displayed is restricted.

33. The system of claim 9, wherein the one or more second participants comprises a second user and a third user,
wherein receiving individual permissions for the one or more users comprises receiving individual permissions for the second user for the first application and the second application and receiving individual permissions for the third user for the first application and the second application.

34. The system of claim 33, wherein receiving individual permissions for the second and third users comprises receiving individual permission for the second user to view the first and second applications and receiving individual permission for the third user to view the first application but not the second application, and
wherein causing only one of the selected set of applications to be displayed at a time to the one or more second participants having individual permission to view the one of the selected set of applications through the meeting application during the unified communication comprises:
causing only one of the first application or the second application to be displayed at a time to the second participant session based on a most recent selection or user interaction through the first user input with the with the first and second applications; and
causing only the first application and not the second application to be displayed to the third participant.

35. The system of claim 9, wherein receiving individual permissions comprises receiving a profile-based permission from the first participant and determining individual permissions for the one or more second participants based on profile information for the individual one or more second participants and the received profile-based permission.

36. The system of claim 35, wherein the profile-based permission includes at least one of an organization or a specific group within an organization, and
wherein determining the individual permissions comprises providing permission for the one or more second participants within the organization or within the specific group of the organization.

37. The system of claim 35, wherein the profile-based permission includes a registration status for the unified communication session, wherein the registration status comprises one of registered and not registered, and
wherein determining the individual permissions comprises providing permission for the one or more second participants registered for the unified communication session.
